(19) United States
(12) Patent Application Publication
(10) Pub. No.: US 2019/0016916 A1
(43) Pub. Date: Jan. 17, 2019

(54) HIGH-GLOSS PAINT COMPOSITION FOR INTERIOR PART

(71) Applicant: KCC CORPORATION, Seoul (KR)

(72) Inventors: Jae Joon MOON, ULSAN (KR); Sang Chan MA, ULSAN (KR); Young Seok CHO, ULSAN (KR); Jung Woo LEE, ULSAN (KR)

(73) Assignee: KCC CORPORATION, Seoul (KR)

(21) Appl. No.: 16/071,786

(22) PCT Filed: Jan. 20, 2017
(86) PCT No.: PCT/KR2017/000738

§ 371 Date: Jul. 20, 2018

(30) Foreign Application Priority Data
Jan. 22, 2016 (KR) 10-2016-0008083

(51) Int. Cl. C09D 175/06; C08G 18/42; C08G 18/62; C08G 18/40; C08G 18/73; C08G 18/24; C09D 7/65; C08K 3/04

(52) U.S. Cl. CPC C09D 175/06; C08G 18/42; C08G 18/622; C08K 3/04; C08G 18/73; C08G 18/246; C09D 7/65; C08G 18/4063

(57) ABSTRACT

Embodiments relate to a high-gloss paint composition for interior parts, which can guarantee excellent appearance and drying property at a relatively low temperature and can realize coating properties such as adhesion, moisture tolerance, and chemical resistance. According to at least one embodiment, there is provided a high-gloss paint composition for interior parts, including: 25 parts by weight to 30 parts by weight of a polyester resin; 35 parts by weight to 40 parts by weight of an acrylic polyol resin; 10 parts by weight to 20 parts by weight of a colorant; 0.5 part by weight to 2 parts by weight of an ultraviolet (UV) absorber; and 10 parts by weight to 25 parts by weight of a solvent based on total 100 parts by weight of the composition.

### CROSS-REFERENCE TO RELATED APPLICATIONS

This application claims the benefit of and priority to PCT/KR2017/000738, filed on Jan. 20, 2017, entitled (translation), “HIGH-GLOSS PAINT COMPOSITION FOR INTERIOR PART,” which claims the benefit of and priority to Korean Patent Application No. 10-2016-0008083, filed on Jan. 22, 2016, each of which is incorporated by reference in its entirety into this application.

### BACKGROUND

### Field

Embodiments relate to a high-gloss paint composition for interior parts.

### Description of the Related Art

With respect to high-gloss paints for automotive interior parts, ABS(Acrylonitrile butadiene styrene) or PC/ABS(Poly-carbonate Acrylonitrile butadiene styrene)-based materials are coated with a multi-layer coating composed of base paint-clear paint, and it was common to coat each layer. However, the demand for BTX (B: benzene, T: toluene, X: xylene)-free paint tends to increase as environmental issues, such as volatile organic compound (VOC) regulations, have emerged.

With respect to high-gloss paint coating, in order to increase crosslinking density in a coated film to ensure necessary appearance and coating properties of the coated film, the settings of drying temperature and drying time are essentially required. However, since coating conditions of the high-gloss paint in a typical coating line include a temperature of 80° C. and a time of 30 minutes in which the drying temperature is set to be high and the drying time is set to be short, it is disadvantageous in that the coating properties of the coated film are significantly reduced.

Korean Patent No. 10-917393 relates to an ultraviolet (UV)-curing paint composition capable of expressing colors, wherein it exhibits suitable coating properties in terms of heat resistance, cosmetic resistance, adhesion, or abrasion. However, there is a limitation in maintaining and improving a black high-gloss image of a high-gloss plastic substrate by coating the substrate with the UV-curing paint composition.

Thus, there is an urgent need to develop a high-gloss top coat paint composition which is suitable for coating interior parts.

### SUMMARY

Embodiments of the subject application provide a high-gloss paint composition for interior parts, which may guarantee excellent appearance and drying properties at a relatively low temperature and may realize coating properties, such as adhesion, moisture tolerance, and chemical resistance, of a coated film.

According to at least one embodiment, there is provided a high-gloss paint composition for interior parts is provided which includes 25 parts by weight to 30 parts by weight of a polyester resin, 35 parts by weight to 40 parts by weight of an acrylic polyol resin, 10 parts by weight to 20 parts by weight of a colorant, 0.5 part by weight to 2 parts by weight of an ultraviolet (UV) absorber, and 10 parts by weight to 25 parts by weight of a solvent based on total 100 parts by weight of the composition.

Various embodiments provide a high-gloss paint composition for interior parts which are used for ABS or PC/ABS materials as materials for automotive interior parts, such that a process may be shortened from a typical 2-coat process (black base paint coating and clear paint coating) to a 1-coat process. According to various embodiments, excellent appearance and coating properties, such as adhesion, moisture tolerance, light resistance, and chemical resistance, of a coated film may be achieved even at a relatively low drying temperature (70° C.) by an appropriate combination of resins, and particularly, hydrolysis of the coated film may be prevented under moisture-tolerance conditions.

### DETAILED DESCRIPTION

Hereinafter, various embodiments will be described in more detail.

According to at least one embodiment, there is provided a high-gloss paint composition for interior parts (hereinafter, referred to as ‘paint composition’), which includes 25 parts by weight to 30 parts by weight of a polyester resin, 35 parts by weight to 40 parts by weight of an acrylic polyol resin, 10 parts by weight to 20 parts by weight of a colorant, 0.5 part by weight to 2 parts by weight of an ultraviolet (UV) absorber, and 10 parts by weight to 25 parts by weight of a solvent based on total 100 parts by weight of the composition.

The paint composition according to at least one embodiment may exhibit excellent coating properties, such as adhesion, moisture tolerance, light resistance, and appearance, of a coated film while maintaining excellent coating workability, and, particularly, may prevent hydrolysis of the coated film under moisture-tolerance conditions. Specifically, the paint composition according to at least one embodiment may satisfy appearance, workability, and coating properties of the coated film at the same time by a combination of the polyester resin contributing to the coated film appearance and workability and the acrylic polyol resin contributing to the coating properties of the coated film.

The polyester resin included in the paint composition according to at least one embodiment may play a role in improving linearity (CF value) and impact resistance after coating and may exhibit good coated film appearance by improving gloss and leveling property through crosslinking with isocyanate as a curing agent.

For example, the polyester resin may have a weight-average molecular weight of 1,500 to 2,000, a hydroxyl value of 130 mg KOH/g to 145 mg KOH/g, and a Tg (Glass transition temperature) of −70° C. to −30° C.

In a case in which the weight-average molecular weight of the polyester resin is less than 1,500, coating workability may be reduced, and, in a case in which the weight-average molecular weight of the polyester resin is greater than 2,000, glossy appearance of the coated film may be degraded. Also, in a case in which the hydroxyl value of the polyester resin is less than 130 mg KOH/g, curing reactivity may be reduced, and, in a case in which the hydroxyl value of the polyester resin is greater than 145 mg KOH/g, adhesion of the coated film may be reduced.

An amount of the polyester resin may be in a range of 25 parts by weight to 30 parts by weight based on the total 100 parts by weight of the composition. In a case in which the amount of the polyester resin is less than 25 parts by weight, cracks may occur in the coated film or the appearance of the coated film may be degraded, and, in a case in which the amount of the polyester resin is greater than 30 parts by weight, since hardness of the coated film may be reduced or surface stickiness may occur, the appearance of the coated film may be degraded.

According to at least one embodiment, the acrylic polyol resin included in the paint composition plays a role in increasing the hardness of the coated film and improving the adhesion with respect to a material. The acrylic polyol resin, for example, may have a weight-average molecular weight of 12,000 to 15,000 and a hydroxyl value of 50 mg KOH/g to 80 mg KOH/g. In a case in which the weight-average molecular weight of the acrylic polyol resin is less than 12,000, the hardness of the coated film may be reduced, and, in a case in which the weight-average molecular weight of the acrylic polyol resin is greater than 15,000, workability may be reduced. Also, in a case in which the hydroxyl value of the acrylic polyol resin is less than 50 mg KOH/g, the coated film may be uncured, and, in a case in which the hydroxyl value of the acrylic polyol resin is greater than 80 mg KOH/g, the curing reactivity may be reduced.

An amount of the acrylic polyol resin may be in a range of 35 parts by weight to 40 parts by weight based on the total 100 parts by weight of the composition. In a case in which the amount of the acrylic polyol resin is less than 35 parts by weight, the hardness of the coated film may be reduced or the adhesion of the coated film may be reduced due to a decrease in water resistance, and, in a case in which the amount of the acrylic polyol resin is greater than 40 parts by weight, moisture tolerance of the coated film may be reduced.

The colorant included in the paint composition according to at least one embodiment, for example, may include at least one selected from the group consisting of carbon black, yellow iron oxide, titanium oxide, phthalocyanine blue, phthalocyanine green, quinacridone red, and perylene red.

An amount of the colorant may be in a range of 10 parts by weight to 20 parts by weight based on the total 100 parts by weight of the composition. In a case in which the amount of the colorant is less than 10 parts by weight, hiding power of the coated film may be reduced, and, in a case in which the amount of the colorant is greater than 20 parts by weight, a leveling property of the coated film may be reduced.

The ultraviolet (UV) absorber included in the paint composition according to at least one embodiment may be a hindered amine light stabilizer, and plays a role in improving weatherability.

An amount of the ultraviolet (UV) absorber may be in a range of 0.5 part by weight to 2 parts by weight based on the total 100 parts by weight of the composition. In a case in which the amount of the ultraviolet (UV) absorber is less than 0.5 part by weight, light resistance of the coated film may be reduced, and, in a case in which the amount of the ultraviolet (UV) absorber is greater than 2 parts by weight, since storability of the paint composition may be reduced or prices of raw materials may rise, economic efficiency may be reduced.

The solvent included in the paint composition according to at least one embodiment may include at least one solvent selected from the group consisting of an ester-based solvent, an aromatic-based solvent, and a ketone-based solvent. The ester-based solvent may include ethyl acetate, n-butyl acetate, cellosolve acetate, propylene glycol monomethyl acetate, or 3-methoxybutyl acetate. The aromatic-based solvent may include toluene, butyl cellosolve, methyl cellosolve, or xylene. The ketone-based solvent may include cyclohexanone, methylamine ketone, diisobutyl ketone, methyl ethyl ketone, or the like.

An amount of the solvent may vary depending on a thickness of the coated film and a method of forming the coated film, wherein the amount of the solvent may be in a range of 10 parts by weight to 25 parts by weight based on the total 100 parts by weight of the composition. In a case in which the amount of the solvent is less than 10 parts by weight, the workability may be reduced, and, in a case in which the amount of the solvent is greater than 25 parts by weight, the appearance of the coated film may be degraded.

The paint composition according to at least one embodiment may further include at least one additive selected from the group consisting of a curing accelerator, a wetting agent, and a pot-life retarder. Dibutyltin dilaurate may be used as the curing accelerator and plays a role in improving a curing reaction rate. A polyether siloxane-based compound may be used as the wetting agent and plays a role in improving wettability during coating and the leveling property of the coated film. 3-mercaptopropionate may be used as the pot-life retarder.

An amount of the additive may be in a range of 0.1 part by weight to 10 parts by weight based on the total 100 parts by weight of the composition.

The paint composition according to at least one embodiment may form a coated film by being mixed with a curing agent. In this case, a hexamethylene diisocyanate trimer-based curing agent having excellent non-yellowing properties and weatherability may be used as the curing agent.

An amount of the curing agent used during the mixing of the paint composition according to at least one embodiment with the curing agent may be in a range of 1 part by weight to 15 parts by weight based on the total 100 parts by weight of the composition. In a case in which the amount of the curing agent mixed is outside the above range, since an unreacted hydroxyl group or curing agent remains, there may be a limitation in the formation of the coated film.

Hereinafter, various embodiments will be described in more detail, according to specific examples. However, the following examples are merely provided to allow for a clearer understanding of the various embodiments, rather than to limit the scope thereof.

### EXAMPLES AND COMPARATIVE EXAMPLES

Each component (unit: parts by weight) was mixed with compositions as listed in Table 1.

Specifically, a polyester resin and an acrylic polyol resin were put in a container, and a ultraviolet (UV) absorber and a solvent were added thereto, while mixing at a low speed (500 rpm) using a stirrer, and stirred for 10 minutes to prepare a mixed solution. After a wetting agent and a curing accelerator were added to a separate container and stirred for 10 minutes, the mixture was mixed with the above-prepared mixed solution and a black colorant was then finally added while stirring to prepare a paint composition.

A mixture, in which the paint composition and a curing agent were mixed, was coated on a ABS based material, and a separately prepared clear paint (dried coat thickness: 30 to 35 microns) was coated thereon, dried at 70° C. for 30 minutes in a drying oven, and cured to form a final coated film. Coating workability and appearance and coating properties of the final coated film were measured as follows, and the results thereof are presented in Table 2 below.

TABLE 1

| | | | Compar- | Compar- | Compar- |
|---|---|---|---|---|---|
| | Exam- | Exam- | ative | ative | ative |
| | ple 1 | ple 2 | Example 1 | Example 2 | Example 3 |
| Polyester resin A | 30 | 25 | 20 | 35 | — |
| Polyester resin B | — | — | — | — | 30 |
| Acrylic polyol | 35 | 40 | 45 | 30 | 35 |
| resin | | | | | |
| Wetting agent | 0.9 | 0.9 | 0.9 | 0.9 | 0.9 |
| Curing | 0.7 | 0.7 | 0.7 | 0.7 | 0.7 |
| accelerator | | | | | |
| ultraviolet | 0.8 | 0.8 | 0.8 | 0.8 | 0.8 |
| (UV) absorber | | | | | |
| Solvent | 17.6 | 17.6 | 17.6 | 17.6 | 17.6 |
| Black colorant | 15 | 15 | 15 | 15 | 15 |
| Curing agent | 10 | 10 | 10 | 10 | 10 |

Polyester resin A: weight-average molecular weight of 1,600, hydroxyl value of 130 mg KOH/g to 145 mg KOH/g, and Tg of −50° C.

Polyester resin B: weight-average molecular weight of 1,000, hydroxyl value of 70 mg KOH/g to 85 mg KOH/g

Acrylic polyol resin: weight-average molecular weight of 12,000 to 15,000, hydroxyl value of 66 mg KOH/g, and Tg of 60° C.

Wetting agent: polyether-modified polydimethylsiloxane solution (BYK)

Curing accelerator: dibutyltin dilaurate (BASF)

ultraviolet (UV) absorber: hindered amine light stabilizer (BASF)

Solvent: mixed solvent including n-butyl acetate, methyl ethyl ketone, and dibutyl ketone (weight ratio based on total 100 parts by weight of the solvent=6:3:1)

Black colorant: carbon black

Curing agent: hexamethylene diisocyanate (HDI), hydroxyl value of 50 mg KOH/g

1) Coating Workability

A tin plate having a size of 30 cm×40 cm was reciprocally coated twice using an IWATA 61 gun, and a degree of atomization and a degree of leveling of the paint compositions during the coating and their ability to be applied thickly were compared.

2) Appearance

After a plastic base was coated with each paint composition and dried at 70° C. for 30 minutes, degrees of bubbles, foreign matter, spots, grooves, and leveling on surfaces of the coated films were compared.

3) Adhesion

A degree of exfoliated portions among 100 squares with a size of 1 mm×1 mm after a tape adhesion test was observed according to ASTM D3359, a tape adhesion test method.

4) Moisture Tolerance

After the coated films were immersed in a constant temperature bath at 40° C. for 10 days, adhesion test and appearance evaluation were performed.

5) Chemical Resistance

The coated films were rubbed 10 times with prescribed chemicals (sunscreen, acetone) under a load of 500 g to measure degrees of discoloration of the coated films.

6) Light Resistance

After applying an energy of 1,050 kJ using a xenon weatherometer, appearance, color difference, and adhesion of the coated films were compared.

TABLE 2

| | | | Compar- | Compar- | Compar- |
|---|---|---|---|---|---|
| | Exam- | Exam- | ative | ative | ative |
| Item | ple 1 | ple 2 | Example 1 | Example 2 | Example 3 |
| Coating | ⊚ | ⊚ | Δ | ◯ | Δ |
| workability | | | | | |
| Appearance | ⊚ | ◯ | Δ | Δ | ◯ |
| Adhesion | ⊚ | ⊚ | ◯ | Δ | Δ |
| Moisture | ⊚ | ⊚ | X | ⊚ | ⊚ |
| tolerance | | | | | |
| Chemical | ⊚ | ⊚ | ⊚ | ⊚ | ⊚ |
| resistance | | | | | |
| Light resistance | ⊚ | ⊚ | ⊚ | ⊚ | ⊚ |

Evaluation:
⊚—excellent,
◯—good,
Δ—fair,
X—poor

As illustrated in Table 2, with respect to Examples and 2 as the paint compositions according to various embodiments, it was confirmed that coating properties, such as adhesion, moisture tolerance, light resistance, chemical resistance, and the like, of the coated films were excellent even at a low drying temperature (70° C.). However, with respect to Comparative Example 1 in which a small amount of the polyester resin was included and an excessive amount of the acrylic polyol resin was included, there were limitations in that coating workability and appearance of the coated film were degraded. Also, with respect to Comparative Example 2 in which an excessive amount of the polyester resin was included and a small amount of the acrylic polyol resin was included, there were limitations in that adhesion and appearance of the coated film were degraded.

We claim:

1. A high-gloss paint composition for interior parts, comprising:
25 parts by weight to 30 parts by weight of a polyester resin;
35 parts by weight to 40 parts by weight of an acrylic polyol resin;
10 parts by weight to 20 parts by weight of a colorant;
0.5 part by weight to 2 parts by weight of an ultraviolet (UV) absorber; and
10 parts by weight to 25 parts by weight of a solvent based on total 100 parts by weight of the composition.

2. The high-gloss paint composition for interior parts of claim 1, wherein the polyester resin has a weight-average molecular weight of 1,500 to 2,000 and a hydroxyl value of 130 mg KOH/g to 145 mg KOH/g.

3. The high-gloss paint composition for interior parts of claim 1, wherein the acrylic polyol resin has a weight-average molecular weight of 12,000 to 15,000 and a hydroxyl value of 50 mg KOH/g to 80 mg KOH/g.

4. The high-gloss paint composition for interior parts of claim 1, wherein the colorant comprises at least one selected from the group consisting of carbon black, yellow iron oxide, titanium oxide, phthalocyanine blue, phthalocyanine green, quinacridone red, and perylene red.

5. The high-gloss paint composition for interior parts of claim 1, further comprising at least one additive selected from the group consisting of a curing accelerator, a wetting agent, and a pot-life retarder.
